(19) United States
(12) Patent Application Publication
(10) Pub. No.: US 2012/0307650 A1
(43) Pub. Date: Dec. 6, 2012

(54) MULTIPLEX SYSTEM

(75) Inventors: Yoshio Kameda, Tokyo (JP); Hideaki Saito, Tokyo (JP)

(73) Assignee: NEC Corporation, Tokyo (JP)

(21) Appl. No.: 13/577,412

(22) PCT Filed: Dec. 21, 2010
(86) PCT No.: PCT/JP2010/073667

§ 371 Date: Aug. 6, 2012

(30) Foreign Application Priority Data
Feb. 10, 2010 (JP) 2010-027538

(51) Int. Cl. H04L 12/26

(52) U.S. Cl. 370/242

(57) ABSTRACT

At least one of components of a multiplex system can detect a failure by itself. An output of the multiplex system is determined from outputs of the components and a failure detection notification. Thus, a multiplex system having higher reliability is provided. A multiplex system 1 includes a plurality of components including a component A1 (10a), a component B1 (10b), and a component C1 (10c) that cannot detect a failure by itself and a component A2 (20a) and a component B2 (20b) that can detect a failure by itself. Outputs 11a, 11b, 11c, 21a, and 21b of the components and failure detection notifications 22a and 22b are inputted to an output determination part 30. The output determination part 30 determines an output of the multiplex system 1 from the outputs of the components and the failure detection notifications.

### TECHNICAL FIELD

The present invention relates to a multiplex system including a plurality of components having the same function, and more particularly to a multiplex system in which at least one of a plurality of components is capable of failure detection.

### BACKGROUND ART

Various mechanical systems, electrical systems, and computing systems have been used in infrastructures such as factories, plants, or network systems. As failure of those systems is fatal, high reliability has been required for those systems.

One of methods of enhancing the reliability of a system includes using a multiplex system in which a plurality of components having the same function are prepared and operated in parallel.

For example, FIG. 5 shows an example of a configuration of a multiplex system. Since the number of components is two, this system is also referred to as a duplex system. Signals are duplexed with a component A (10a) and a component B (10b) having the same function. An output determination part 30 determines an output of the duplex system 5 depending upon outputs 11a and 11b of the components. As shown in FIG. 5a, if a failure occurs in one of the components in the duplex system 5 (a failure occurs in the component B (10b) of FIG. 5a), then the output determination part 30 can detect the failure of the component because the outputs X and X′ of the components are inconsistent. Such a system is disclosed in JP-A 2003-177935 (Patent Literature 1).

Another example of multiplex systems is a multiplex calculation system disclosed in JP-A 2009-276983 (Patent Literature 2). Outputs of multiplexed processors are inputted to a majority decision circuit, which determines an output of the multiplexed processors. FIG. 5 of Patent Literature 2 discloses a multiplex calculation system having three processors operable in parallel. Whether data and addresses of the respective lines are correct is detected by a data majority decision circuit and an address majority decision circuit. Two coincident outputs are regarded as being correct, and the operation continues with those coincident outputs. When a failure diagnosis circuit detects a failure from the correctness of the data and the addresses of the respective lines, then the operation of the failed line is stopped. The system can continue to operate even if one of the lines fails.

### SUMMARY OF THE INVENTION

### Problem(s) to be Solved by the Invention

Patent Literature 2 is silent on an output of the multiplex calculation system in a case where the correctness cannot be decided by majority.

With the duplex system illustrated in FIG. 5, if a failure occurs in one of the components, occurrence of the failure can be detected as already disclosed in FIG. 5a. However, the duplex system cannot determine which output X or X′ is correct. Therefore, the duplex system cannot determine which component suffers from a failure. In other words, if a failure occurs in a duplex system, a correct value cannot be outputted, and the duplex system is stopped.

Furthermore, as shown in FIG. 5b, if failures occur in both of the components of the duplex system such that outputs of those components coincide with X′ due to similar failures, then the output determination part 30 determines that the output of the duplex system is X′, which is an error, because there is no inconsistency. Thus, the duplex system cannot avoid an error output. In other words, a duplex system may output an error if two failures occurs concurrently.

In the system of Patent Literature 2, the multiplicity is set to be not less than three. Even if more failures occur, it is possible to determine and output a correct value by means of majority decision. Therefore, the system of Patent Literature 2 can provide higher reliability. However, more components are generally needed to increase the multiplicity, causing an increase of cost.

The present invention has been made in view of the above circumstances. The present invention provides a multiplex system that can achieve high reliability without an increase of cost.

### Means to Solve the Problem(s)

According to an aspect of the present invention, there is provided a multiplex system including a plurality of components having the same function. At least one of the components can detect a failure by itself. The multiplex system comprises an output determination part operable to determine an output of the system from outputs of the components and a failure detection notification from the component that can detect a failure by itself.

### Advantageous Effect of the Invention

According to an aspect of the present invention, since at least one of components in a multiplex system is formed of a component that can detect a failure by itself, failure detection can be performed solely by the components. Therefore, higher reliability can be achieved.

Furthermore, this failure detection does not increase the number of components. Therefore, high reliability can be achieved without an increase of the cost.

### BRIEF DESCRIPTION OF DRAWINGS

FIG. 1 is a block diagram showing a configuration of a multiplex system according to a first exemplary embodiment of the present invention.

FIG. 2 is a block diagram showing a configuration of a multiplex (duplex) system according to a second exemplary embodiment of the present invention.

FIG. 2a is a diagram explanatory of an operation in a case where a failure occurs in the multiplex (duplex) system according to the second exemplary embodiment according to the present invention.

FIG. 2b is a diagram explanatory of an operation in a case where a failure occurs in the multiplex (duplex) system according to the second exemplary embodiment according to the present invention.

FIG. 2c is a diagram explanatory of an operation in a case where failures occur in the multiplex (duplex) system according to the second exemplary embodiment according to the present invention.

FIG. 3 is a block diagram showing a configuration of a multiplex (triplex) system according to a third exemplary embodiment of the present invention.

FIG. 3a is a diagram explanatory of an operation in a case where a failure occurs in the multiplex (triplex) system according to the third exemplary embodiment according to the present invention.

FIG. 3b is a diagram explanatory of an operation in a case where a failure occurs in the multiplex (triplex) system according to the third exemplary embodiment according to the present invention.

FIG. 3c is a diagram explanatory of an operation in a case where failures occur in the multiplex (triplex) system according to the third exemplary embodiment according to the present invention.

FIG. 3d is a diagram explanatory of an operation in a case where failures occur in the multiplex (triplex) system according to the third exemplary embodiment according to the present invention.

FIG. 4 is a block diagram showing a configuration of a multiplex (triplex) system according to a fourth exemplary embodiment of the present invention.

FIG. 4a is a diagram explanatory of in operation in a case where failures occur in the multiplex (triplex) system according to the fourth exemplary embodiment according to the present invention.

FIG. 4b is a diagram explanatory of an operation in a case where failures occur in the multiplex (triplex) system according to the fourth exemplary embodiment according to the present invention.

FIG. 5 is a block diagram showing a configuration of a conventional multiplex (duplex) system.

FIG. 5a is a diagram explanatory of an operation in a case where a failure occurs in the conventional multiplex (duplex) system.

FIG. 5b is a diagram explanatory of an operation in a case where failures occur in the conventional multiplex (duplex) system.

### MODE(S) FOR CARRYING OUT THE INVENTION

In an embodiment, a multiplex system includes a plurality of components having the same function and an output determination part operable to determine an output of the multiplex system from outputs of the plurality of components. At least one of the components can detect a failure by itself. The determination part determines the output of the multiplex system from the outputs of the components and a failure detection notification from the component that can detect a failure by itself.

In an embodiment, if the components that can detect a failure by itself include one or more components that do not output a failure detection notification, the output determination part determines to use, as the output of the multiplex system, one of the outputs of the components that do not output a failure detection notification.

In an embodiment, if all of the components that can detect a failure by itself output a failure detection notification and there are one or more components other than the components that can detect a failure by itself, then the output determination part determines to use, as the output of the multiplex system, one of the outputs of the components other than the components that can detect a failure by itself.

In an embodiment, if all of the components that can detect a failure by itself output a failure detection notification and there are no components other than the components that can detect a failure by itself, then the output determination part does not change an output value of the multiplex system.

In an embodiment, if all of the components that can detect a failure by itself output a failure detection notification and there are no components other than the components that can detect a failure by itself then the output determination part uses a preset value as the output of the multiplex system.

In an embodiment, if all of the components that can detect a failure by itself output a failure detection notification, and there are two or more components other than the components that can detect a failure by itself, and a majority of the components other than the components that can detect a failure by itself have the same output, then the output determination part uses, as the output of the multiplex system, the output of the majority of the components.

In an embodiment, if all of the components that can detect a failure by itself output a failure detection notification, and there are two or more components other than the components that can detect a failure by itself, and a majority of the components other than the components that can detect a failure by itself do not have the same output, or there are no two or more components other than the components that can detect a failure by itself, then the output determination part does not change an output value of the multiplex system.

In an embodiment, if all of the components that can detect a failure by itself output a failure detection notification, and there are two or more components other than the components that can detect a failure by itself, and a majority of the components other than the components that can detect a failure by itself do not have the same output, or there are no two or more components other than the components that can detect a failure by itself, then the output determination part uses a preset value as the output of the multiplex system.

In another embodiment, there is provided a method of determining an output of a multiplex system including a plurality of components. The multiplex system includes at least one first component that can detect a failure by itself and at least one second component that cannot detect a failure by itself but has the same function as the first component. The output determining method comprises determining an output of the multiplex system from outputs of the first component and the second component and a failure detection notification of the first component.

If the first component includes one or more components that do not output a failure detection notification, one of the outputs of the components that do not output the failure detection notification is used as an output of the multiplex system.

Next, exemplary embodiments of the present invention will be described with reference to the drawings.

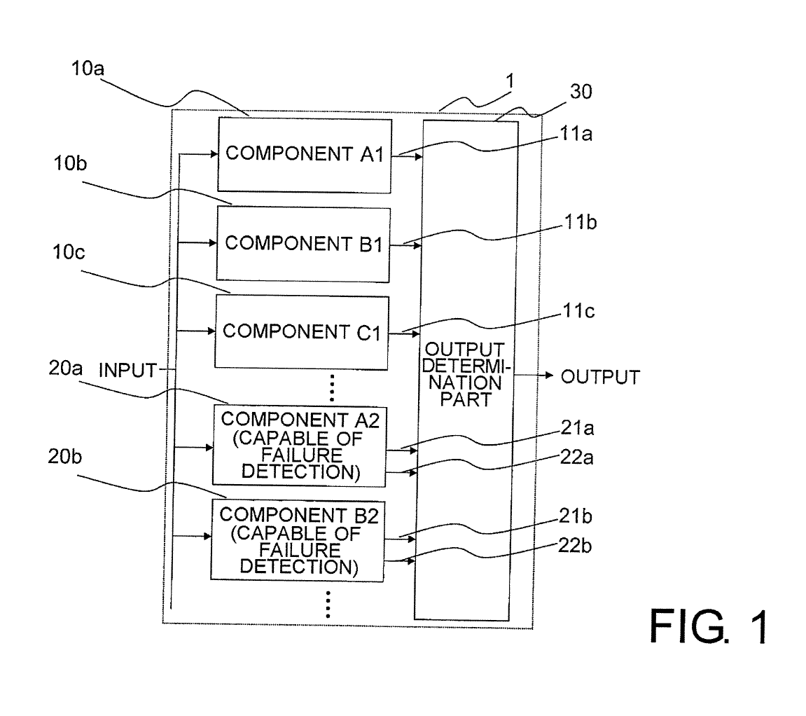

FIG. 1 is a block diagram showing a configuration of a multiplex system according to a first exemplary embodiment of the present invention. In the drawings that will be described, the same type of component blocks are denoted by the same reference numerals.

Referring to FIG. 1, the multiplex system 1 has a plurality of components including a component A1 (10a), a component B1 (10b), and a component C1 (10c), which cannot detect a failure by itself, and a component A2 (20a) and a component B2 (20b), which can detect a failure by itself. Those components share an input of the multiplex system 1 with each other. Furthermore, outputs 11a, 11b, 11c, 21a, and 21b of the respective components and failure detection notifications 22a and 22b are inputted to an output determination part 30. An output of the output determination part 30 is used as an output of the multiplex system 1. FIG. 1 illustrates that the number of components that cannot detect a failure by itself is three and that the number of components that can detect a failure by itself is two. However, the number of components that cannot detect a failure by itself and the number of components that can detect a failure by itself are not limited to those values as long as the number of components that can detect a failure by itself is not less than one and the sum of the number of components that cannot detect a failure by itself and the number of components that can detect a failure by itself is not less than two.

Detection of a failure is performed by detection of an abnormal value with a sensor in a mechanical system or an electrical system, or by encoding represented by parity or checking with arithmetical operations of a remainder in a computing system. With those failure detection methods, generally, cost for area, electric power, and weight is lower as compared to a case where the same components are used and compared with each other.

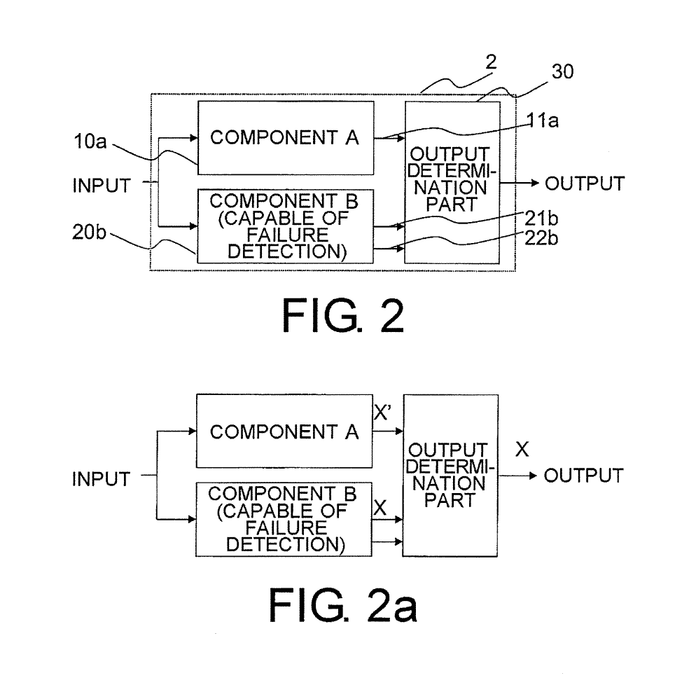

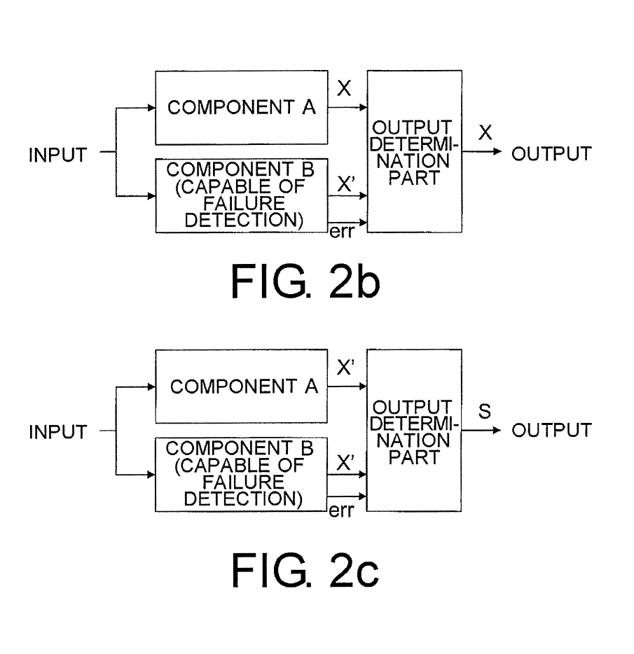

FIG. 2 is a block diagram showing a configuration of a multiplex (duplex) system according to a second exemplary embodiment of the present invention.

Referring to FIG. 2, the duplex system 2 includes a component A (10a) that cannot detect a failure by itself and a component B (20b) that can detect a failure by itself. Those components share an input of the duplex system 2 with each other. Outputs 11a and 21b of those components and a failure detection notification 22b are inputted to an output determination part 30. An output of the output determination part 30 is used as an output of the duplex system 2.

FIG. 2a is a diagram explanatory of an operation in a case where a failure occurs in the component A of the second exemplary embodiment according to the present invention. It is assumed that the component A outputs an error X′ resulting from the failure and that the component B outputs a correct value X without any failure. Because the output determination part has received no failure detection notification from the component B that can detect a failure by itself, it determines to use the output X of the component B as an output of the output determination part. Thus, the duplex system outputs the correct value X.

FIG. 2b is a diagram explanatory of an operation in a case where a failure occurs in the component B of the second exemplary embodiment according to the present invention. It is assumed that the component A outputs a correct value X without any failure and that the component B outputs an error X′ resulting from the failure and also outputs a failure detection notification err. Because the output determination part has received the failure detection notification from the component B that can detect a failure by itself, it does not use the output of the component B and determines to use the output X of the component A as an output of the output determination part. Thus, the duplex system outputs the correct value X.

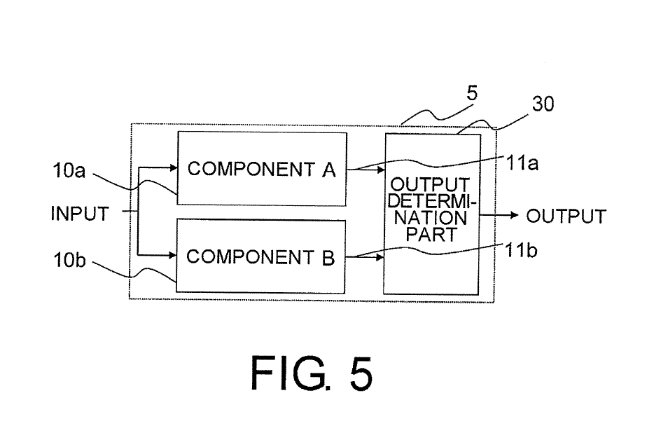

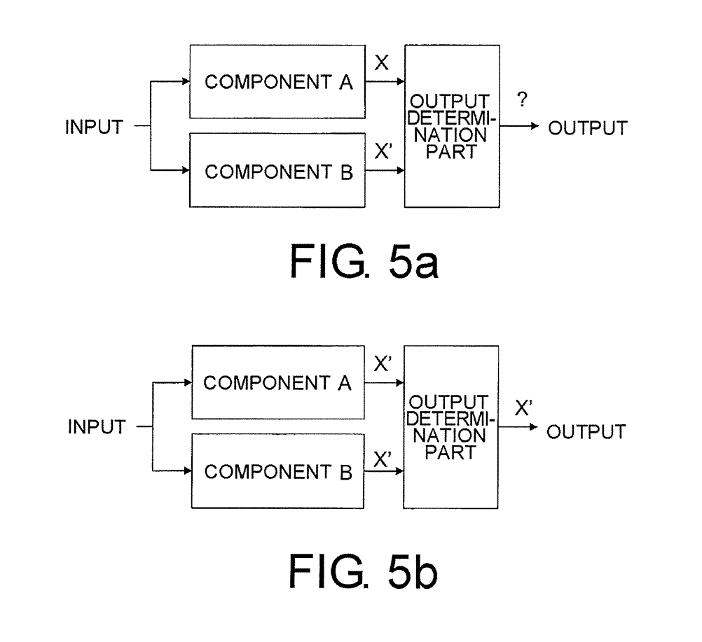

As shown in FIG. 5a, when a failure occurs, the conventional duplex system can detect the failure but cannot output a correct value. In contrast, as shown in FIGS. 2a and 2b, the duplex system can output a correct value X in the second exemplary embodiment even if a failure occurs. Thus, the duplex system can provide higher reliability.

FIG. 2c is a diagram explanatory of an operation in a case where failures occur in the component A and the component B of the second exemplary embodiment according to the present invention. It is assumed that the component A outputs an error X′ resulting from the failure and that the component B outputs the same error X′ resulting from the similar error and also outputs a failure detection notification err. Since the output determination part has received the failure detection notification from the component B that can detect a failure by itself, it does not use the output of the component B. Because there are no two or more components that can detect a failure by itself other than the component B, the output determination part determines a preset output S as an output of the output determination part. Thus, the duplex system outputs the preset output S. It is preferable to determine the preset output S such that the preset output S does not cause a dangerous situation to the external. For example, a red signal is generally used as a preset output in a traffic signal. Alternatively, the output determination part may hold the preceding output without changing its output, which is not illustrated in FIG. 2c.

As shown in FIG. 5b, the conventional duplex system outputs an error X′ when two failures occur concurrently so that the components output coincident outputs X′ resulting from the similar failures. In contrast, as shown in FIG. 2c, even if two failures occur concurrently, the second exemplary embodiment does not output the error X′. Thus, the second exemplary embodiment can provide higher reliability.

In the second exemplary embodiment, whether to use an output of a component that cannot detect a failure by itself (the component A in FIG. 2) if the output determination part receives a failure detection notification from a component that can detect a failure by itself (the component B in FIG. 2) can be determined depending upon the reliability required for the duplex system. Specifically, the output of the component A is used if the duplex system should cope with no more than one failure. If the duplex system should cope with two or more failures for higher reliability, it is preferable not to use the output of the component A.

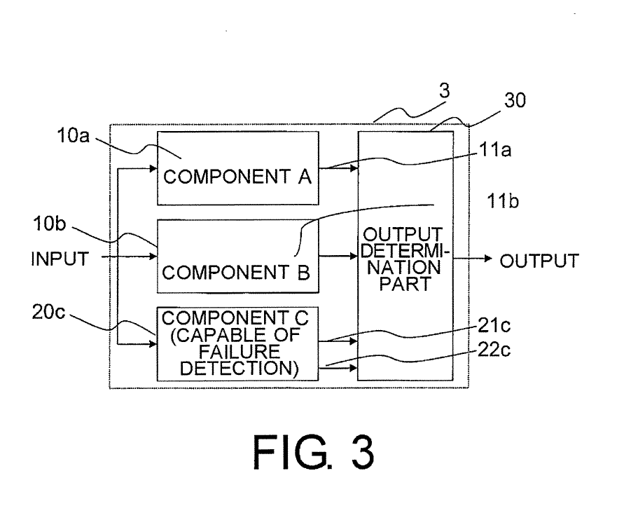

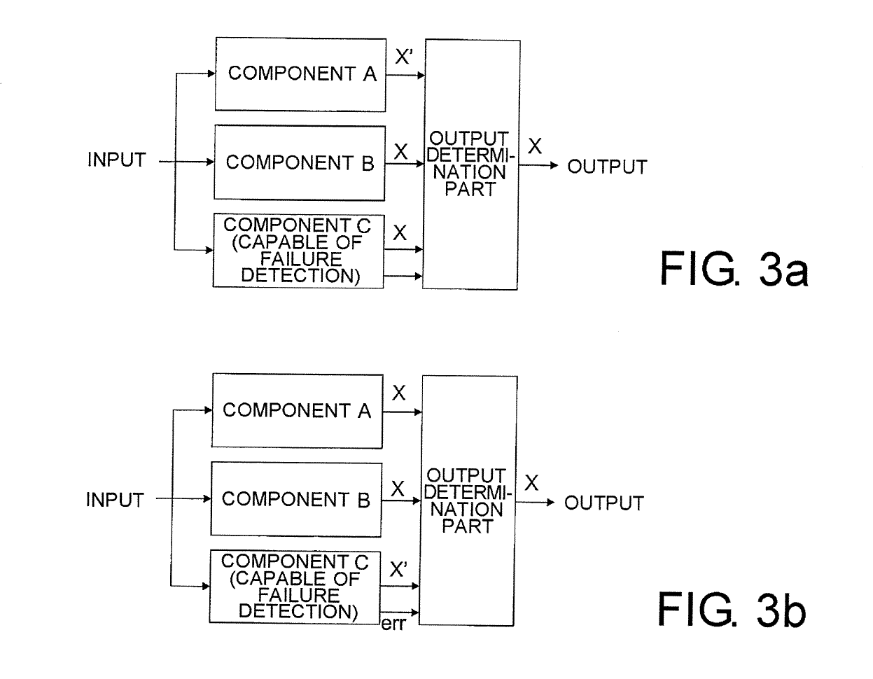

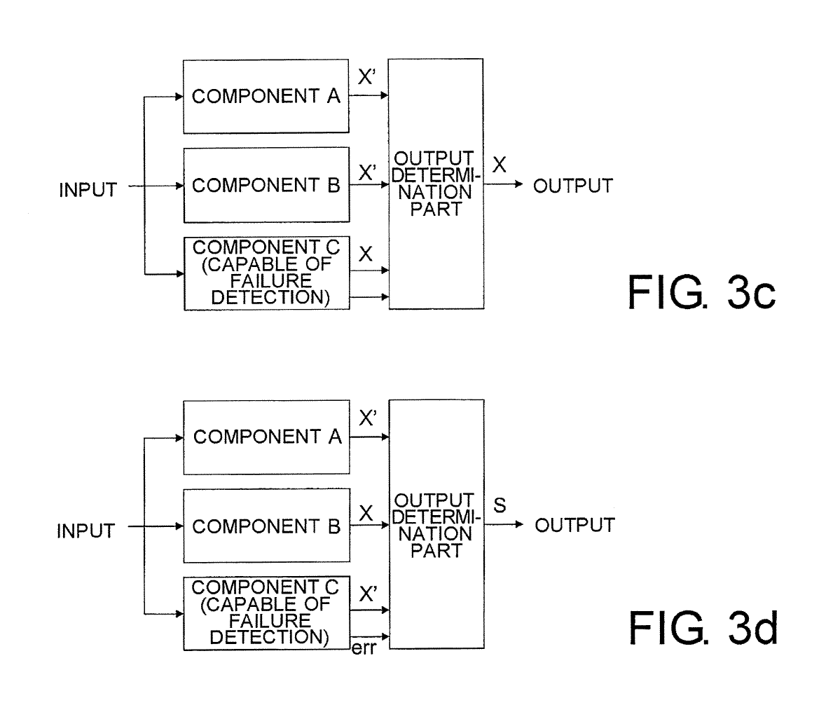

FIG. 3 is a block diagram showing a configuration of a multiplex (triplex) system according to a third exemplary embodiment of the present invention.

Referring to FIG. 3, the triplex system 3 includes a component A (10a) and a component B (10b) that cannot detect a failure by itself and a component C (20c) that can detect a failure by itself. Those components share an input of the triplex system 3 with each other. Outputs 11a, 11b, and 21c of those components and a failure detection notification 22c are inputted to an output determination part 30. An output of the output determination part 30 is used as an output of the triplex system 3.

FIG. 3a is a diagram explanatory of an operation in a case where a failure occurs in the component A of the third exemplary embodiment according to the present invention. It is assumed that the component A outputs an error X′ resulting from the failure and that the components B and C output a correct value X without any failure. Because the output determination part has received no failure detection notification from the component C that can detect a failure by itself, it determines to use the output X of the component C as an output of the output determination part. Thus, the triplex system outputs the correct value X.

FIG. 3b is a diagram explanatory of an operation in a case where a failure occurs in the component C of the third exemplary embodiment according to the present invention. It is assumed that the components A and B output a correct value X without any failure and that the component C outputs an error X′ resulting from the failure and also outputs a failure detection notification err. Because the output determination part has received the failure detection notification from the component C that can detect a failure by itself, it does not use the output of the component C. Although the output determination part has received the failure notification from all of the component(s) that can detect a failure by itself, there are two components other than the component that can detect a failure by itself. In other words, there are two components (the component A and the component B) that cannot detect a failure by itself. Outputs of a majority of those two components are the same. Therefore, the output determination part determines to use the output X of those components as an output of the output determination part. Thus, the triplex system outputs the correct value X.

FIG. 3c is a diagram explanatory of an operation in a case where failures occur in the component A and the component B of the third exemplary embodiment according to the present invention. It is assumed that the component A and the component B output an error X′ resulting from the failure and that the component C outputs a correct'value X without any failure. Because the output determination part has received no failure detection notification from the component C that can detect a failure by itself, it determines to use the output X of the component C as an output of the output determination part. Thus, the triplex system outputs the correct value X.

FIG. 3d is a diagram explanatory of an operation in a case where failures occur in the component A and the component C of the third exemplary embodiment according to the present invention. It is assumed that the component A and the component C output an error X′ resulting from the failure, that the component C outputs a failure detection notification err, and that the component B outputs a correct value X without any failure. Because the output determination part has received a failure detection notification from the component C that can detect a failure by itself, it does not use the output of the component C. Although the output determination part has received the failure notification from all of the component(s) that can detect a failure by itself, there are two components other than the component that can detect a failure by itself. In other words, there are two components (the component A and the component B) that cannot detect a failure by itself. Outputs of a majority of those two components are not the same. Therefore, the output determination part determines to use a preset output value S as an output of the output determination part. Thus, the triplex system outputs the preset value S, which is safe. Alternatively, the output determination part may hold the preceding output without changing its output, which is not illustrated in FIG. 3d.

If two failures occur so as to cause the same error in the conventional triplex system, an error may be outputted by majority decision. In contrast, even if two failures occur in the triplex system of the third exemplary embodiment, the triplex system can output a correct value X as shown in FIG. 3b or output a safe value S as shown in FIG. 3d. Thus, the triplex system of the third exemplary embodiment can provide higher reliability without outputting an error.

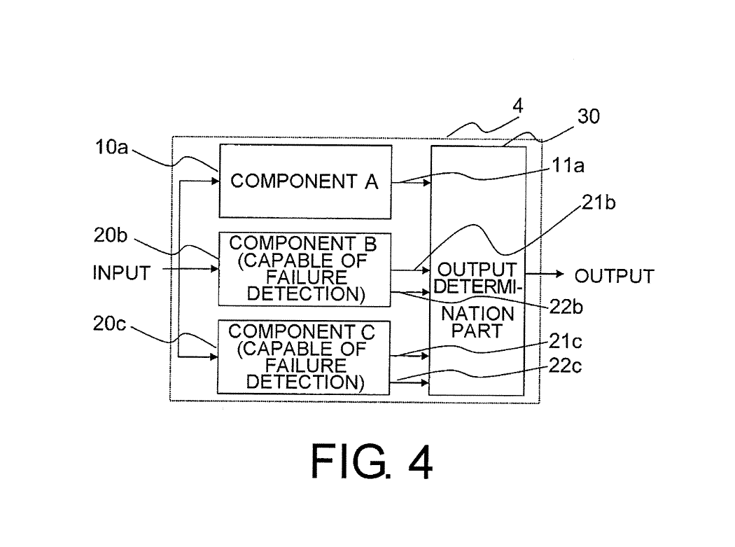

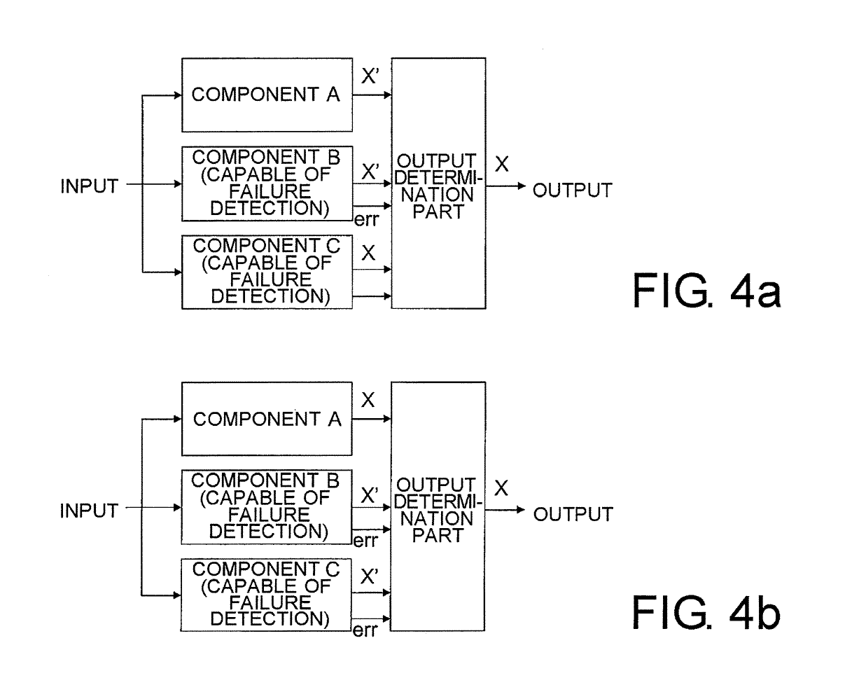

FIG. 4 is a block diagram showing a configuration of a multiplex (triplex) system according to a fourth exemplary embodiment of the present invention.

Referring to FIG. 4, the triplex system 4 includes a component A (10a) that cannot detect a failure by itself and a component B (20b) and a component C (20c) that can detect a failure by itself. Those components share an input of the triplex system 4 with each other. Outputs 11a, 21b, and 21c of those components and failure detection notifications 22b and 22c are inputted to an output determination part 30. An output of the output determination part 30 is used as an output of the triplex system 4.

FIG. 4a is a diagram explanatory of an operation in a case where failures occur in the component A and the component B of the fourth exemplary embodiment according to the present invention. It is assumed that the component A and the component B output an error X′ resulting from the failure, that the component B outputs a failure detection notification err, and that the component C outputs a correct value X without any failure. Because the output determination part has received no failure detection notification from the component C that can detect a failure by itself, it determines to use the output X of the component C as an output of the output determination part. Thus, the triplex system outputs a correct value X.

FIG. 4b is a diagram explanatory of an operation in a case where failures occur in the component 13 and the component C of the fourth exemplary embodiment according to the present invention. It is assumed that the component A outputs a correct value X without any failure and that the component B and the component C output an error X′ resulting from the failure and also output a failure detection notification err. The output determination part has received the failure notifications from all of the components that can detect a failure by itself. There is a component A that cannot detect a failure by itself other than the components that can detect a failure by itself. Therefore, the output determination part determines to use the output X of the component A as an output of the output determination part. Thus, the triplex system outputs a correct value X.

If two failures occur so as to cause the same error in the conventional triplex system, an error may be outputted by majority decision. In contrast, even if two failures occur in the triplex system of the fourth exemplary embodiment, the triplex system can output a correct value X as shown in FIGS. 4a and 4b. Thus, the triplex system of the fourth exemplary embodiment can provide higher reliability without outputting an error.

If higher reliability is required on the assumption that three or more failures occur concurrently, the output determination part may operates as follows: When failures occur in the component B and the component C as shown in FIG. 4b, the output determination part has received failure notifications from all of the components that can detect a failure by itself. There are no two or more components that cannot detect a failure by itself, other than the components that can detect a failure by itself. Therefore, the output determination part may output a safe preset output S or may hold the preceding output without changing its output.

Although the present invention has been described along with the above exemplary embodiments, the present invention is not limited to the configurations of the aforementioned embodiments. As a matter of course, a variety of variations and modifications that would be apparent to those skilled in the art are included in the scope of the present invention.

Some or all of the above exemplary embodiments can be described as in the following notes. Nevertheless, the present invention is not limited to those notes.

(Note 1) A multiplex system including a plurality of components having the same function, wherein at least one of the components can detect a failure by itself, and the multiplex system comprises an output determination part operable to determine an output of the multiplex system from outputs of the components and a failure detection notification from the component that can detect a failure by itself.

(Note 2) The multiplex system as recited in Note 1, wherein, if the components that can detect a failure by itself include one or more components that do not output a failure detection notification, the output determination part determines to use, as the output of the multiplex system, one of the outputs of the components that do not output a failure detection notification.

(Note 3) The multiplex system as recited in Note 1, wherein, if all of the components that can detect a failure by itself output a failure detection notification and there are one or more components other than the components that can detect a failure by itself, then the output determination part determines to use, as the output of the multiplex system, one of the outputs of the components other than the components that can detect a failure by itself.

(Note 4) The multiplex system as recited in Note 1, wherein, if all of the components that can detect a failure by itself output a failure detection notification and there are no components other than the components that can detect a failure by itself, then the output determination part does not change an output value of the multiplex system.

(Note 5) The multiplex system as recited in Note 1, wherein, if all of the components that can detect a failure by itself output a failure detection notification and there are no components other than the components that can detect a failure by itself, then the output determination part uses a preset value as the output of the multiplex system.

(Note 6) The multiplex system as recited in Note 1, wherein, if all of the components that can detect a failure by itself output a failure detection notification, and there are two or more components other than the components that can detect a failure by itself, and a majority of the components other than the components that can detect a failure by itself have the same output, then the output determination part uses, as the output of the multiplex system, the output of the majority of the components.

(Note 7) The multiplex system as recited in Note 1, wherein, if all of the components that can detect a failure by itself output a failure detection notification, and there are two or more components other than the components that can detect a failure by itself, and a majority of the components other than the components that can detect a failure by itself do not have the same output, or there are no two or more components other than the components that can detect a failure by itself, then the output determination part does not change an output value of the multiplex system.

(Note 8) The multiplex system as recited in Note 1, wherein, if all of the components that can detect a failure by itself output a failure detection notification, and there are two or more components other than the components that can detect a failure by itself, and a majority of the components other than the components that can detect a failure by itself do not have the same output, or there are no two or more components other than the components that can detect a failure by itself, then the output determination part uses a preset value as the output of the multiplex system.

(Note 9) A method of determining an output of a multiplex system including a plurality of components, wherein the multiplex system includes a first component that can detect a failure by itself and a second component that cannot detect a failure by itself but has the same function as the first component, and the method comprises determining an output of the multiplex system from outputs of the first component and the second component and a failure detection notification of the first component.

(Note 10) The method of determining an output of a multiplex system as recited in Note 9, wherein, if the first component includes one or more components that do not output a failure detection notification, one of the outputs of the components that do not output the failure detection notification is used as an output of the multiplex system.

(Note 11) A multiplex system including a plurality of components having the same function, wherein the multiplex system includes a first component that can detect a failure by itself and a second component that cannot detect a failure by itself but has the same function as the first component, and also includes an output determination part operable to determine an output of the multiplex system from outputs of the first component and the second component and a failure detection notification of the first component.

This application claims the benefit of priority from Japanese patent application No. 2010-027538, filed on Feb. 10, 2010, the disclosure of which is incorporated herein in its entirety by reference.

1. A multiplex system comprising:
a plurality of components having the same function, wherein at least one of the plurality of components can detect a failure by itself; and
an output determination part operable to determine an output of the multiplex system from outputs of the plurality of components and a failure detection notification from the component that can detect a failure by itself.

2. The multiplex system as recited in claim 1, wherein, if the components that can detect a failure by itself comprise one or more components that do not output a failure detection notification, the output determination part determines to use, as the output of the multiplex system, one of the outputs of the components that do not output a failure detection notification.

3. The multiplex system as recited in claim 1, wherein, if all of the components that can detect a failure by itself output a failure detection notification and there are one or more components other than the components that can detect a failure by itself, then the output determination part determines to use, as the output of the multiplex system, one of the outputs of the components other than the components that can detect a failure by itself.

4. The multiplex system as recited in claim 1, wherein, if all of the components that can detect a failure by itself output a failure detection notification and there are no components other than the components that can detect a failure by itself, then the output determination part does not change an output value of the multiplex system.

5. The multiplex system as recited in claim 1, wherein, if all of the components that can detect a failure by itself output a failure detection notification and there are no components other than the components that can detect a failure by itself, then the output determination part uses a preset value as the output of the multiplex system.

6. The multiplex system as recited in claim 1, wherein, if all of the components that can detect a failure by itself output a failure detection notification, and there are two or more components other than the components that can detect a failure by itself, and a majority of the components other than the components that can detect a failure by itself have the same output, then the output determination part uses, as the output of the multiplex system, the output of the majority of the components.

7. The multiplex system as recited in claim 1, wherein, if all of the components that can detect a failure by itself output a failure detection notification, and there are two or more components other than the components that can detect a failure by itself, and a majority of the components other than the components that can detect a failure by itself do not have the same output, or there are no two or more components other than the components that can detect a failure by itself, then the output determination part does not change an output value of the multiplex system.

8. The multiplex system as recited in claim 1, wherein, if all of the components that can detect a failure by itself output a failure detection notification, and there are two or more components other than the components that can detect a failure by itself, and a majority of the components other than the components that can detect a failure by itself do not have the same output, or there are no two or more components other than the components that can detect a failure by itself, then the output determination part uses a preset value as the output of the multiplex system.

9. A method of determining an output of a multiplex system comprising a plurality of components, wherein the multiplex system comprises at least one first component that can detect a failure by itself and at least one second component that cannot detect a failure by itself but has the same function as the first component, the method comprising: determining an output of the multiplex system from outputs of the first component and the second component and a failure detection notification of the first component.

10. The method of determining an output of a multiplex system as recited in claim 9, wherein, if the first component comprises one or more components that do not output a failure detection notification, one of the outputs of the components that do not output the failure detection notification is used as an output of the multiplex system.
